(19) United States
(12) Patent Application Publication
(10) Pub. No.: US 2014/0085022 A1
(43) Pub. Date: Mar. 27, 2014

(54) Synthesis of Magnetic Composites

(71) Applicant: Robert Bosch GmbH, Stuttgart (DE)

(72) Inventors: Alexandra Wilde, Renningen (DE); Katharina Kleinehakenkamp, Bucuresti (RO); Jochen Gaenzle, Leinfelden-Echterdingen (DE); Jutta Riessen, Stuttgart (DE); Ulrich Eisele, Stuttgart (DE)

(73) Assignee: Robert Bosch GmbH, Stuttgart (DE)

(21) Appl. No.: 13/981,574

(22) PCT Filed: Nov. 29, 2011
(86) PCT No.: PCT/EP2011/071226

§ 371 Date: Dec. 9, 2013

(30) Foreign Application Priority Data
Jan. 26, 2011 (DE) 102011003193.6

(51) Int. Cl. H01F 41/02; H01F 1/12; H01F 1/032

(52) U.S. Cl. CPC H01F 41/0253; H01F 1/032; H01F 1/12
USPC 335/302; 204/471

(57) ABSTRACT

The present disclosure relates to a method for producing magnetic composites, comprising the electrophoretic deposition of hard-magnetic particles and soft-magnetic particles from a suspension onto an electrode, as well as the composite produced by means of the method and the use thereof for producing permanent magnets.

### PRIOR ART

Permanent magnets having a high energy density are of great importance in many industrial fields. For the purposes of the present invention, a permanent magnet is a magnet made of one piece of a magnetizable material which retains its static magnetic field without a flow of current being required. Permanent magnets can be produced from various materials, for example steel, ferrites, bismanol (bismuth and manganese), aluminum-nickel-cobalt (AlNiCo), samarium-cobalt (SmCo) or neodymium-iron-boron (NdFeB). The strongest permanent magnet which is commercially available today is an NdFeB magnet.

A further increase in the energy density of a magnet, i.e. the magnetic energy per unit volume of a magnet, would make it possible to increase the efficiency of electric motors, to reduce the weight of a magnet for a given energy density and/or to reduce the space requirement for a magnet of the same energy density. An increase in the energy density of magnets can be achieved by exchange coupling between hard-magnetic and soft-magnetic particles which are in direct contact with one another (Coehorn et al.; J. Phys. Colloq. 49 (1988) C8-669; Skomski et al.; Phys. Rev. B 48 (1993) 15812). According to these theoretical considerations, the effect is particularly strong when both hard-magnetic particles and soft-magnetic particles are present in a size of the order of the Bloch wall thickness, i.e. typically nanosize.

Although the principle of exchange-coupled magnets was described about 20 years ago, it has hitherto been implemented in practice with only limited success.

Permanent magnets are usually produced from crystalline powder, preferably from a single-crystal and single-domain powder. The powder is pressed in a mold in the presence of a strong magnetic field. This results in alignment of the crystals with their preferential axis of magnetization in the direction of the magnetic field. The compounds are subsequently sintered. At the sintering temperature, which is above 1000° C., the externally effective magnetization is lost because the thermal motion of the atoms leads to largely antiparallel alignment of the spin. Since the crystalline orientation and thus the magnetocrystalline preferential direction of the grains in the sintered composite is maintained, the magnetic parallel alignment can be restored by means of a sufficiently strong magnetization impulse after cooling of the magnets.

The nanostructuring of the specimens necessary for exchange coupling can in principle be obtained by compacting of nanoparticles or by suitable processing of the volume material in the course of the conventional production processes for permanent magnets. However, when nanoparticles are used, there is the difficulty of compacting these particles by means of conventional processes, for example by means of pressing, to form an ordered solid. For the purposes of the present invention, the term ordered solid means that the two phases, namely the hard-magnetic phase and the soft-magnetic phase, are in a regular alternating spatial arrangement with an only slightly varying characteristic length of a single-phase region. In order to achieve the desired high energy densities of magnets, a solid having a typical length of a phase in the order of magnitude of the Bloch wall thickness, e.g. from 1 to 100 nm, is required.

Specimens produced by nanostructuring of the volume material are known from the prior art. However, only isotropic materials have been described hitherto (Goll and Kronmüller, Naturwissenschaften 87 (2000) 423-438), since induction of a preferential direction has not been possible because of the heat treatment temperature which is greater than the Curie temperature. Although the energy densities of these materials are above those of comparable isotropic materials which are not exchange-coupled, they are below those of anisotropic magnets which are not exchange-coupled, e.g. the commercially available, sintered NdFeB magnets. For this reason, the magnets which have been able to be obtained hitherto by nanostructuring are of only limited relevance both from a technical and economical point of view.

CN-1085963 A describes a process for the electrophoretic coating of the surface of a negative electrode composed of NdFeB-magnetic material, in which the oily dirt and adhesive are removed by boiling before the material is provided with an anionic electrophoretic coating.

CN-101013628 A discloses a process for protecting porous magnets and for sealing by means of cathode electrophoresis. CN-1619718 A, too, describes a process of cathode electrophoresis using a bonded NdFeB magnet.

### DISCLOSURE OF THE INVENTION

In electrophoresis, particles which have an electric charge on the surface are deposited on an electrode in a dielectric liquid in an electric field. In the case of perfect dispersion of the particles, they retain their disperse status until they are deposited. As a result, they can find an energetically favorable place, i.e. in a gap between previously deposited particles, on deposition. In electrophoresis, consolidation of the particles is (in contrast to most other shaping methods) not determined by local friction which would lead to a poorly and irregularly packed body.

In electrophoresis, the speed of deposition is independent of the size of the particles. Electrophoresis is thus the only powder-metallurgical shaping process in which the speed of consolidation is independent of the particle size. Electrophoresis is therefore predestined for the processing of nanosize powders. Electrophoretic deposition of particles from a suspension enables ordered arrangement of the particles to occur. In particular, in the case of electrophoretic deposition of nanosize particles from a suspension, the ordered arrangement of the nanosize particles makes it possible to produce a body having nanoscale order by subsequent densification by sintering.

In the case of an ordered body which can be produced by the process of the invention, a hard-magnetic phase and a soft-magnetic phase, each present in the form of particles, are joined to form a solid, i.e. a composite, which has spatially regularly arranged phases having a characteristic length. When nanosize particles are used for the hard-magnetic phase and the soft-magnetic phase, bodies having nanoscale order can be produced by the process of the invention.

Suitable process modifications make it possible to achieve texturing or anisotropy of the solid, for example by application of an external magnetic field, by the use of anisotropic particles or of particles having a particular shape and/or particular flow conditions in the electrophoresis chamber and/or by means of specific arrangements of the electrodes.

The present invention provides a process for producing magnetic composites, which comprises electrophoretic deposition of hard-magnetic particles and soft-magnetic particles from a suspension on an electrode. Deposition is carried out with the aid of a suitable electric field between typically two electrodes, with deposition of the particles preferably taking place on an electrode. Particularly uniformly ordered composites can be produced by means of this process.

In a particularly preferred embodiment of the process, the hard-magnetic particles and the soft-magnetic particles are nanosize. The use of nanosize particles makes it possible to produce particularly uniformly ordered nanocomposites which can be processed further to produce permanent magnets, preferably permanent magnets having a high energy density.

The hard-magnetic particles and the soft-magnetic particles are preferably selected from the group consisting of metallic materials, intermetallic compounds and oxidic materials. Oxidic materials are, for example, ferrites. Ferrites are ferromagnetic ceramic materials which have poor electrical conductivity or are electrically not conductive and consist of a compound of iron oxide, nickel oxide, zinc oxide, manganese oxide, barium oxide, strontium oxide and/or other metal oxides, where the compound is represented by the general formula AB₂O₄ in which A=Fe(II), Ni, Zn, Mn, Ba, Sr, etc. and B=Fe(III). A distinction is made between soft-magnetic ferrites and hard-magnetic ferrites. Hard-magnetic ferrites contain barium and/or strontium in addition to the iron oxide and are produced by calcination from iron(III) oxide and barium carbonate or strontium carbonate. Soft-magnetic ferrites are produced by addition of nickel, zinc and/or manganese compounds.

In a further or additional embodiment of the process of the invention, the hard-magnetic particles and/or the soft-magnetic particles display anisotropy. Anisotropy refers to the directional dependence of a property or a process. The use of particles which display anisotropy makes it possible to achieve a directed arrangement of these particles in the composite.

As starting material for the process of the invention, use is made of a suspension which comprises the desired particles in the desired ratio and with a suitable solids content in a suitable suspension medium.

Suitable materials for the soft-magnetic particles can be selected from the group consisting of iron, alloys based on iron, iron carbides, nickel and cobalt, soft ferrites such as NiZn or MnZn.

Suitable materials for the hard-magnetic particles can be selected from the group consisting of cobalt-samarium (SmCo₅, Sm₂CO₁₇, Sm(Co, Cu, Fe, Zr)_{z}), neodymium-iron-boron (NdFeB), AlNiCo alloys, hard ferrites based on barium, hard ferrites based on strontium, PtCo alloys, CuNiFe alloys, CuNiCo alloys, FeCoCr alloys, martensitic steels and MnAlC alloys.

It is in principle possible to mix particles composed of different soft-magnetic materials with particles composed of different hard-magnetic materials with one another and use this mixture as one of the starting materials for the electrophoretic process of the invention. Particular preference is given to using a combination of nanosize NdFeB as hard-magnetic particles and nanosize Fe as soft-magnetic particles.

The size of the nanosize particles is from 1 to 100 nm, preferably from 10 to 60 nm, particularly preferably from 20 to 40 nm.

In a preferred embodiment, the solids content of the suspension is from 5 to 30% by volume, particularly preferably from 10 to 20% by volume.

Suspension media suitable for the process are water-free organic solvents having an appropriate relative permittivity (“dielectric constant”) of about 5-70. For the purposes of the invention, the term water-free organic solvents encompasses effectively water-free organic solvents. Effectively water-free organic solvents are organic solvents having a water content of less than 0.5% by weight, preferably less than 0.2% by weight. Particularly preferred suspension media are selected from the group consisting of isopropanol, n-butanol, 1-methoxy-2-propanol and acetone and have a relative permittivity of 10-25.

The electrophoretic deposition of the particles, in particular of the nanosize particles, from the suspension on the electrode is carried at nominal electric field strengths of from 10 to 10⁷ V/m. The electrophoretic deposition of the particles, in particular the nanosize particles, from the suspension is preferably carried out at nominal electric field strengths of from 1000 to 10 000 V/m. The current density is preferably in the range from 0.01 to 5000 A/m², particularly preferably from 1 to 50 A/m².

In particular embodiments of the process of the invention, the suspension of the particles comprises at least one additive which is preferably selected from the group consisting of polymeric binders and dispersants.

Suitable polymeric binders can be selected from the group consisting of acrylate binders, preferably from the group consisting of methacrylates having an intermediate molecular weight. Particularly preferred polymeric binders from the group consisting of methacrylates having an intermediate molecular weight are shown in the following table and are, for example, commercially available under the trade name ELVACYTE from Lucite International, Cordova, Tenn., USA.

TABLE 1
Overview of particularly preferred polymeric
binders. The inherent viscosity was measured on a
solution of 0.25 g of polymeric binder in 50 ml of
methylene chloride at 20° C. by means of a No. 50 Cannon-
Fenske viscometer.

| | Elvacyte | | |
|---|---|---|---|
| | 2009 ® | Elvacyte 2014 ® | Elvacyte 2045 ® |
| Polymer | methyl | methyl methacrylate | isobutyl |
| | methacrylate | | methacrylate |
| Molecular weight | 81 000 | 119 000 | 193 000 |
| Glass transition | 87° C. | 41° C. | 50° C. |
| temperature | | | |
| Inherent viscosity | 0.369-0.415 | 0.370-0.430 | 0.590-0.680 |
| Acid number | 0 | 13 | 0 |

Suitable dispersants can be selected from the group consisting of trioxadecanoic acid (TODS) and polyisobutylsuccinimide.

The additives in the suspension enable the deposition and the morphology of the deposit to be modified.

In the case of another or additional embodiment, a magnetic field is maintained in the electrophoresis chamber during the electrophoretic deposition of the nanosize particles. This enables texturing of the deposit to be produced.

In a further or additional embodiment of the process of the invention, the deposit, i.e. the particles deposited on the electrode, is dried in a closed solvent atmosphere. The solvent of the solvent atmosphere is preferably the same solvent as the suspension medium which was used for the electrophoretic deposition of the particles. Drying cracks in the deposit are avoided as a result of the drying of the deposit in a closed solvent atmosphere.

Permanent magnets having a high energy density can be produced by the process of the invention.

The invention also extends to the magnetic composites produced by the process of the invention and also to the use of the magnetic composites produced by the process of the invention for producing permanent magnets.

1. A process for producing magnetic composites, comprising:
electrophoretically depositing hard-magnetic particles and soft-magnetic particles on an electrode.

2. The process as claimed in claim 1, wherein the hard-magnetic particles and the soft-magnetic particles are nanosize particles.

3. The process as claimed in claim 1, wherein at least one of the hard-magnetic particles and the soft-magnetic particles is selected from the group consisting of metallic materials, intermetallic compounds and oxidic materials.

4. The process as claimed in claim 1, wherein at least one of the hard-magnetic particles and the soft-magnetic particles displays anisotropy.

5. The process as claimed in claim 1, wherein materials for the soft-magnetic particles are selected from the group consisting of iron, alloys based on iron, nickel and cobalt, soft ferrites, NiZn, and MnZn.

6. The process as claimed in claim 1, wherein materials for the hard-magnetic particles are selected from the group consisting of cobalt-samarium (SmCo₅, Sm₂Co₁₇), Sm(Co, Cu, Fe, Zr)_{z}), neodymium-iron-boron (NdFeB), AlNiCo alloys, hard ferrites based on barium, hard ferrites based on strontium, PtCo alloys, CuNiFe alloys, CuNiCo alloys, FeCoCr alloys, martensitic steels and MnAlC alloys.

7. The process as claimed in claim 2, wherein a size of the nanosize particles is from 1 to 100 nm.

8. The process as claimed in claim 1, wherein the hard-magnetic particles and the soft-magnetic particles are deposited from a suspension having a solids content of from 5 to 30% by volume.

9. The process as claimed in claim 1, wherein the hard-magnetic particles and the soft-magnetic particles are deposited from a suspension medium including a water-free organic solvent selected from the group consisting of isopropanol, butanol, 1-methoxy-2-propanol and acetone.

10. The process as claimed in claim 2, further comprising:
electrophoretically depositing the nanosize particles at a field strength of up to 10⁷ V/m.

11. The process as claimed in claim 2, further comprising:
electrophoretically depositing the nanosize particles at a current density in a range from 0.01 to 5000 A/m².

12. The process as claimed in claim 1, wherein the hard-magnetic particles and the soft-magnetic particles are deposited from a suspension including at least one additive selected from the group consisting of polymeric binders and dispersants.

13. The process as claimed in claim 2, further comprising:
maintaining a magnetic field in an electrophoresis chamber during the electrophoretic deposition of the nanosize particles.

14. The process as claimed in claim 9, further comprising:
drying the deposit composed of the hard-magnetic particles and the soft-magnetic particles in a closed solvent atmosphere including a solvent identical to the suspension medium.

15. A magnetic composite comprising:
an electrode;
hard-magnetic particles electrophoretically deposited onto the electrode; and
soft-magnetic particles electrophoretically deposited onto the electrode.

16. A process for producing a permanent magnet comprising:
producing a magnetic composite by electrophoretically depositing hard-magnetic particles and soft-magnetic particles on an electrode; and
using the magnetic composite to produce a permanent magnet.

17. The process as claimed in claim 7, wherein the size of the nanosize particles is from 20 to 40 nm.

18. The process as claimed in claim 8, wherein the suspension from which the hard-magnetic particles and the soft-magnetic particles are deposited has a solids content of from 10 to 20% by volume.

19. The process as claimed in claim 10, further comprising:
electrophoretically depositing the nanosize particles at a field strength in a range from 1000 to 10,000 V/m.

20. The process as claimed in claim 11, further comprising:
electrophoretically depositing the nanosize particles at a current density in a range from 1 to 50 A/m².
